(19) United States
(12) Patent Application Publication
(10) Pub. No.: US 2009/0009127 A1
(43) Pub. Date: Jan. 8, 2009

(54) MOTOR CONTROL DEVICE AND ELECTRIC POWER STEERING DEVICE USING THE SAME

(75) Inventors: Yousuke IMAMURA, Maebashi-shi (JP); Lilit KOVUDHIKULRUNGSRI, Maebashi-shi (JP); Shuji ENDO, Maebashi-shi (JP); Kenji MORI, Maebashi-shi (JP)

Correspondence Address: SUGHRUE-265550, 2100 PENNSYLVANIA AVE. NW, WASHINGTON, DC, 20037-3213, US

(73) Assignee: NSK LTD., Tokyo (JP)

(21) Appl. No.: 12/167,904

(22) Filed: Jul. 3, 2008

(30) Foreign Application Priority Data
Jul. 6, 2007 (JP) 2007-178135

(51) Int. Cl. G05B 11/01; H02K 7/14

(52) U.S. Cl. 318/601; 318/3

(57) ABSTRACT

A motor driving control device includes a current instruction value computing section 31 which computes a current instruction value for driving a brushless motor 12, a motor current detector 38 which detects a motor current of the brushless motor 12, a current controller 34 which computes a voltage instruction value based on the current instruction value and the motor current, and a rotation information detector 22 which detects an electric angle and a rotation angular velocity of the brushless motor, and the motor driving control device includes a disturbance compensation voltage computing section 41 which computes a disturbance compensation voltage value base on the current instruction value, the electric angle of the brushless motor, and the rotation angular velocity of the brushless motor, and a feed-forward compensator 35 which corrects a voltage instruction value outputted from the current controller based on the disturbance compensation voltage value computed by the disturbance compensation voltage computing section 41.

### BACKGROUND OF THE INVENTION

The present invention relates to a motor driving control device and electric power steering device using the motor control device including a current instruction value computing section which computes a current instruction value for driving a brushless motor; a motor current detector which detects a motor current of the brushless motor; a current controller which computes a voltage instruction value based on the current instruction value and the motor current; and a rotation information detector which detects an electric angle and a rotation angular velocity of the brushless motor.

Recently, the demand for electric power steering devices has increased and a higher rack force and silence are increasingly requested. In particular, a column type electric power steering device is arranged at a position close to a driver, so that increased silence thereof is demanded. To realize a higher rack force, it is necessary to increase the torque of an electric motor used for the electric power steering device, however, a high-torque motor has a high torque constant, so that the torque ripple increases, and as a result, this leads to increases in vibration and noise. Therefore, it is demanded to configure a high-output system without a size increase while maintaining an excellent torque ripple performance.

To meet these demands, the applicant of the present invention previously proposed a motor driving device and an electric power steering device in which counter electromotive forces ea, eb, and ec of phases are calculated based on a rotation angle θe and an electric angular velocity ω e of a rotor by using a conversion table, the torque is increased by converting these counter electromotive voltages ea, eb, and ec into trapezoid waves or pseudo trapezoid waves, which includes n-order harmonic, the counter electromotive forces ea, eb, and ec are 3-phase/2-phase converted to calculate a d-axis counter electromotive force ed and a q-axis counter electromotive force eq, and a d-axis instruction current value Idref is calculated based on a torque instruction value Tref and an electric angular velocity ωe, and to suppress the torque ripple, a q-axis instruction current value Iqref is calculated based on the following equation (1) by applying an energy balance equation of the motor, a- to c-phase current instruction values are calculated by 2-phase/3-phase converting these d-axis instruction current value Idref and the q-axis instruction current value Iqref, and by performing feedback control based on these a- to c-phase current instruction values, an electric motor is driven (refer to Patent document 1).

Iqref=(⅔Tref×ωm−ed×Idref)/eq (1)

Herein, ωm denotes a mechanical angular velocity obtained by dividing an electric angular velocity ωe by a motor pole pair number P (=ωe/P).
[Patent document 1] JP-A No. 2006-158198 (pages 10 to 12, and FIGS. 8 and 9)

However, the conventional examples described in Patent document 1 have unresolved problem, which is torque ripple caused by counter electromotive voltage distortion. Because, q-axis current instruction value Iqref for determining the motor torque is calculated by applying the energy balance equation based on electromotive forces eq and ed are calculated from a rotor electric angle θe and electric angular velocity ωe, a d-axis current instruction value Idref is calculated based on a torque current instruction value Tref and the electric angular velocity ωe, so that the electromotive forces eq and ed are functions of the motor electric angle θe, and when a current is applied to the motor in actuality, due to an armature magnetomotive force generating inside the motor according to the applied current, the electromotive forces are distorted according to the armature reaction and magnetization characteristics of a stator.

Further, there is an unsolved problem in which, in a high-rotation state, responsiveness of a current control system is lowered, so that a necessary correction current cannot be supplied, and a torque ripple occurs.

### SUMMARY OF THE INVENTION

The present invention is made in view of the unsolved problems of the conventional examples, and an object thereof is to provide a motor driving control device and an electric power steering device using this motor driving control device which are constructed by considering distortion of electromotive forces due to an armature magnetic field of a brushless motor, and constructed so that a necessary correction current can be supplied even in a high-rotation state.

To achieve the above-described object, according to a first aspect of the invention, there is provided a motor driving control device including:

a current instruction value computing section which computes a current instruction value for driving a brushless motor;

a motor current detector which detects a motor current of the brushless motor;

a current controller which computes a voltage instruction value based on the current instruction value and the motor current;

a rotation information detector which detects an electric angle and a rotation angular velocity of the brushless motor;

a disturbance compensation voltage computing section which computes a disturbance compensation voltage value based on the current instruction value, the electric angle of the brushless motor, and the rotation angular velocity of the brushless motor; and

a feed forward compensator which corrects the voltage instruction value outputted from the current controller based on the disturbance compensation voltage value computed in the disturbance compensation voltage computing section.

In the invention according to the first aspect, a disturbance compensation voltage value is computed based on the current instruction value, the rotation angle of the brushless motor and the rotation angular velocity of the brushless motor, and feed-forward compensation for correcting a voltage instruction value outputted from the current controller based on the computed disturbance compensation voltage value is performed, so that an error caused by distortion of the electromotive force EMF according to armature reaction of the brushless motor and current distortion according to responsiveness of a current control system in a high-rotation state can be removed, and the torque ripple can be effectively suppressed.

According to a second aspect of the invention, there is provided the motor driving control device according to the first aspect, wherein

the disturbance compensation voltage computing section has a disturbance compensation voltage model for calculating a disturbance compensation voltage based on the electric angle.

In the invention according to the second aspect, a disturbance compensation voltage is calculated by using a disturbance compensation voltage model based on the rotation angle of the brushless motor detected by the rotation information detector, so that by setting a disturbance compensation voltage model for obtaining a disturbance compensation voltage corresponding to the rotation angle of the brushless motor in advance through simulations and experiments, etc., a disturbance compensation voltage for compensating nonlinear disturbance characteristics of a current control system of a current controller, a motor driving circuit, and a brushless motor, etc., can be obtained.

Further, according to a third aspect of the invention, there is provided the motor driving control device according to the second aspect, wherein

the disturbance compensation voltage computing section includes: a first offset value generator which generates an offset value based on the rotation angular velocity of the brushless motor, to offset the rotation angle, which is inputted into the disturbance compensation voltage model.

In the invention according to the third aspect, for the rotation angle to be inputted into the disturbance compensation voltage model, the first offset value generator generates an offset value based on the rotation angular velocity of the brushless motor, so that a disturbance compensation voltage can be obtained to reduce influence of current distortion according to responsiveness of the current control system.

Further, according to a forth aspect of the invention, there is provided the motor driving control device according to the second aspect, wherein

the disturbance compensation voltage computing section includes: a second offset value generator which generates an offset value based on the current instruction value, to offset the rotation angle, which is inputted into the disturbance compensation voltage model.

In the invention according to the forth aspect, for the rotation angle to be inputted into the disturbance compensation voltage model, the second offset value generator generates an offset value based on the current instruction value, so that a disturbance compensation voltage can be obtained to reduce influence of an error caused by distortion of the electromotive force EMF according to the armature reaction of the brushless motor.

Further, according to a fifth aspect of the invention, there is provided the motor driving control device according to the second aspect, wherein

the disturbance compensation voltage computing section includes: a first corrector which multiplies a disturbance compensation voltage outputted from the disturbance compensation voltage model by a first amplitude gain calculated based on the rotation angular velocity of the brushless motor.

In the invention according to the fifth aspect, the first corrector multiplies a disturbance compensation voltage outputted from the disturbance compensation voltage model by the second amplitude gain calculated based on the rotation angular velocity of the brushless motor, so that the amplitude of the disturbance compensation voltage can be corrected based on the rotation angular velocity, and the influence of the current distortion according to the responsiveness of the current control system can be suppressed.

Further, according to a sixth aspect of the invention, there is provided the motor driving control device according to the second aspect, wherein

the disturbance compensation voltage computing section includes: a second corrector which multiplies a disturbance compensation voltage outputted from the disturbance compensation voltage model by a second amplitude gain calculated based on the current instruction value.

In the invention according to the sixth aspect, the second corrector multiplies a disturbance compensation voltage outputted from the disturbance compensation voltage model by the second amplitude gain calculated based on the current instruction value, so that the amplitude of the disturbance compensation voltage can be corrected based on the current instruction value, and an error caused by distortion of the electromotive force EMF according to armature reaction of the brushless motor can be suppressed.

Further, according to a seventh aspect of the invention, there is provided the motor driving control device according to the second aspect, wherein

the disturbance compensation voltage computing section includes: a phase lead/lag compensator which performs phase lead/lag compensation for the disturbance compensation voltage on an output side of the disturbance compensation voltage model.

In the invention according to the seventh aspect, phase lead/lag compensation is performed for the disturbance compensation voltage by the phase lead/lag compensator provided on the output side of the disturbance compensation voltage model, so that the disturbance can be directly compensated without any influence according to the responsiveness of the current control system.

Further, according to an eighth aspect of the invention, there is provided an electric power steering device, wherein

a brushless motor which generates a steering auxiliary force for a steering system is driven and controlled by the motor driving control device according to the first aspect.

In the invention according to the eighth aspect, an electric power steering device which offers superior silence and responsiveness that prevents being lowered in a high-rotation state can be provided.

According to the present invention, a disturbance compensation voltage is computed according to a rotation angle of the brushless motor by using a current instruction value, the rotation angle of the brushless motor, the rotation angular velocity of the brushless motor, and feed-forward compensation for correcting the voltage instruction value outputted from the current controller based on the computed disturbance compensation voltage is performed, so that the disturbance compensation voltage is calculated based on the rotation angle of the brushless motor, the influence of armature reaction is corrected based on the current instruction value, an influence of the responsiveness of the current control system can be corrected based on the rotation angular velocity of the brushless motor, and without any influence according to the responsiveness of the current control system, an error caused by distortion of electromotive force EMF according to armature reaction of the brushless motor and current distortion according to responsiveness of the current control system are grasped as disturbance, and this disturbance can be directly compensated, the torque ripple can be effectively suppressed, and by improving the responsiveness of the current control system in a high-rotation state and supplying a necessary correction current, the occurrence of the torque ripple can be suppressed.

In addition, a feed-forward compensation system for performing disturbance compensation can be constructed by a simple structure, so that disturbance compensation can be performed with a small computing load.

Further, by applying the motor control device having the above-described effects to an electric power steering device, an electric power steering device which offers superior silence and responsiveness that prevents being lowered in a high-rotation state can be provided.

### BRIEF DESCRIPTION OF THE DRAWINGS

FIG. 1 is an entire construction view showing an embodiment of the present invention.

FIG. 2 is a block diagram showing an example of a steering auxiliary control device.

FIG. 3 is a characteristic line showing a steering auxiliary current instruction value calculation map.

FIG. 4 is a block diagram showing a detailed construction of the disturbance compensation voltage computing section.

FIG. 5 is a characteristic line showing the first offset value calculation map which the first offset value generator refers to.

FIG. 6 is a characteristic line showing the second offset value calculation map which the second offset value generator refers to.

FIG. 7 is a characteristic line showing the disturbance compensation voltage calculation map which the disturbance compensation voltage model refers to.

FIG. 8 is a characteristic line showing the first amplitude gain calculation map which the first amplitude gain calculator refers to.

FIG. 9 is a characteristic line showing the second amplitude gain calculation map which the second amplitude gain calculator refers to.

FIG. 10 is a block diagram showing another example of the disturbance compensation voltage computing section.

FIG. 11 is a block diagram of a steering auxiliary control device showing another embodiment of the present invention.

### DETAILED DESCRIPTION OF THE PREFERRED EMBODIMENTS

Hereinafter, an embodiment of the present invention will be described with reference to the drawings. In this embodiment, description will be given by using a 3-phase brushless motor.

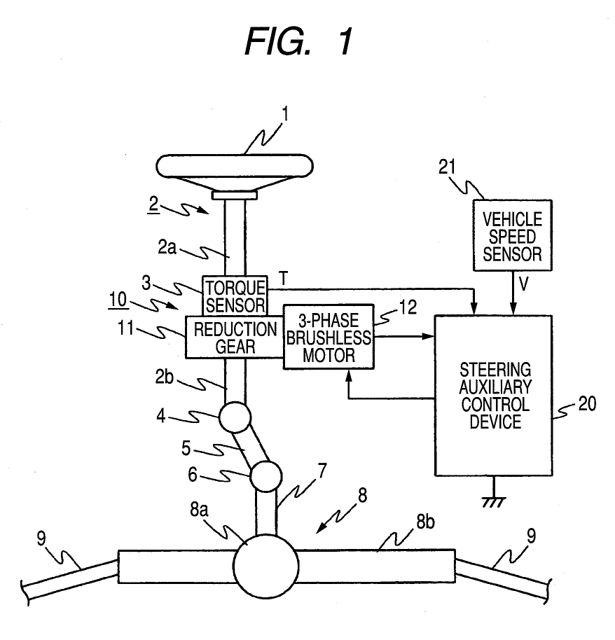

FIG. 1 is an entire construction view showing an embodiment when the present invention is applied to an electric power steering device, and in the figure, the reference numeral 1 denotes a steering wheel, and a steering force applied by a driver to the steering wheel 1 is transmitted to a steering shaft 2 having an input shaft 2a and an output shaft 2b. In this steering shaft 2, one end of the input shaft 2a is coupled to the steering wheel 1, and the other end is coupled to one end of the output shaft 2b via a steering torque sensor 3 as a steering torque detecting means.

The steering force transmitted to the output shaft 2b is transmitted to a lower shaft 5 via a universal joint 4, and further transmitted to a pinion shaft 7 via a universal joint 6. The steering force transmitted to the pinion shaft 7 is transmitted to a tie rod 9 via a steering gear 8 to rotatively steer a rotary wheel not shown. Herein, the steering gear 8 is formed as a rack and pinion type including a pinion 8a coupled to the pinion shaft 7 and a rack 8b which engages with the pinion 8a, and converts a rotative movement transmitted to the pinion 8a into a rectilinear movement by the rack 8b.

To the output shaft 2b of the steering shaft 2, a steering auxiliary mechanism 10 which transmits a steering auxiliary force to the output shaft 2b is coupled. This steering auxiliary mechanism 10 includes a reduction gear 11 coupled to the output shaft 2b and a 3-phase brushless motor 12 which is coupled to the reduction gear 11 and generates a steering auxiliary force. The steering torque sensor 3 detects a steering torque which is applied to the steering wheel 1 and transmitted to the input shaft 2a, and constructed so as to, for example, convert a steering torque into torsion angle displacement of a torsion bar which is interposed between the input shaft 2a and the output shaft 2b and is not shown, and converts this torsion angle displacement into a resistance change or a magnetic change and detects it.

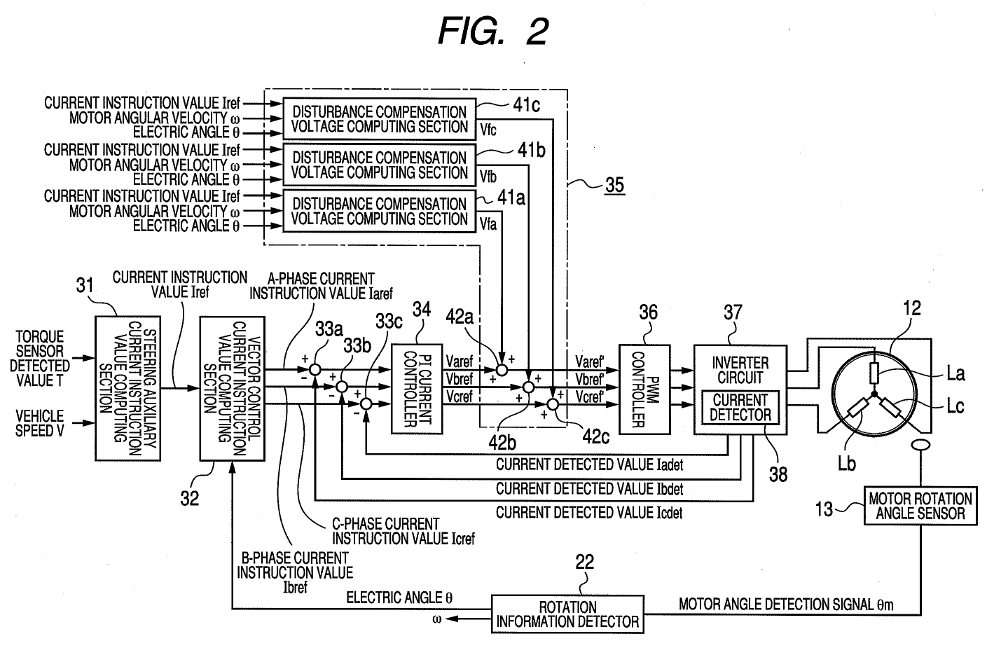

In the 3-phase brushless motor 12, as shown in FIG. 2, one ends of an a-phase coil La, a b-phase coil Lb, and a c-phase coil Lc are connected to each other as star connection, and the other ends of the coils La, Lb, and Lc are connected to a steering auxiliary control device 20 as a motor control device and individually supplied with motor drive currents Ia, Ib, and Ic. The 3-phase brushless motor 12 includes a motor rotation angle sensor 13 including a resolver and a rotary encoder, etc., for detecting a motor rotation angle θm.

Into the steering auxiliary control device 20, a steering torque T detected by the steering torque sensor 3 and a vehicle speed V detected by a vehicle speed sensor 21 are inputted, and a motor rotation angle θm detected by the motor rotation angle sensor 13 is inputted, and an electric angle θ outputted from a rotation information detector 22 which computes the electric angle θ based on the motor rotation angle θm and calculates a motor angular velocity ω by differentiating the motor rotation angle θm, is inputted, and further, motor current detected values Iadet and Icdet outputted from a motor current detector 38 which detects motor currents Ia and Ic supplied to the phase coils La and Lc of the 3-phase brushless motor 12 and Ibdet estimated from the motor current Ia and Ic, are inputted.

This steering auxiliary control device 20 includes a steering auxiliary current instruction value computing section 31 which computes a steering auxiliary current instruction value Iref based on the steering torque T and the vehicle speed V, and a vector control current instruction value computing section 32 which calculates d-axis current instruction value Idref and q-axis current instruction value Iqref by performing a vector control computing operation based on the steering auxiliary current instruction value Iref outputted from the steering auxiliary current instruction value computing section 31 and the electric angle θ, and computes an a-phase current instruction value Iaref, a b-phase current instruction value Ibref, and a c-phase current instruction value Icref for the brushless motor 12 by 2-phase/3-phase converting the d-axis current instruction value Idref and the q-axis current instruction value Iqref.

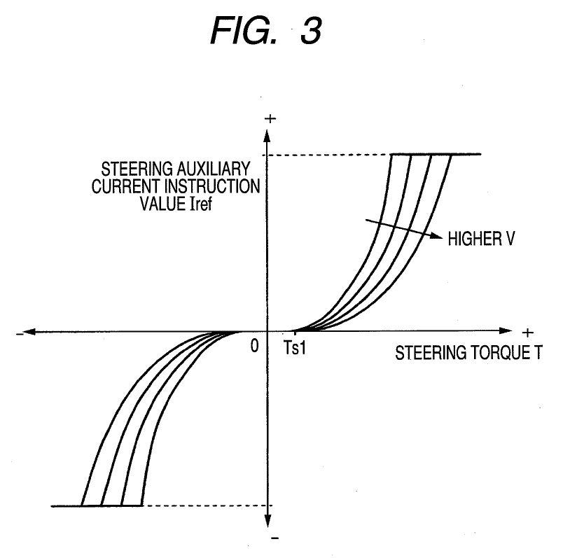

Herein, the steering auxiliary current instruction value computing section 31 calculates a steering auxiliary current instruction value Iref by referring to a steering auxiliary current instruction value calculation map shown in FIG. 3 based on the steering torque T and the vehicle speed V.

This steering auxiliary current instruction value calculation map shows a characteristic line plot shown as a parabolic curve as shown in FIG. 3 which indicates the steering torque T on the horizontal axis and indicates the steering auxiliary current instruction value Iref on the vertical axis, and sets the vehicle speed detected value V as a parameter. At the steering torque T between “0” and the set value Ts1 near 0, the steering auxiliary current instruction value Iref keeps “0,” and when the steering torque T exceeds the set value Ts1, at the beginning, the steering auxiliary current instruction value Iref increases slowly with respect to the increase in steering torque T, however, when the steering torque T further increases, with respect to this increase, the steering auxiliary current instruction value Iref is rapidly increased, and a plurality of such characteristic curves are set so that their gradients become smaller as the vehicle speed increases.

Then, the a-phase current instruction value Iaref, the b-phase current instruction value Ibref, and the c-phase current instruction value Icref outputted from the vector control current instruction value computing section 32 are supplied to subtracters 33a, 33b, and 33c into which the motor current detected values Iadet, Ibdet, and Icdet detected by the motor current detector 38 are inputted.

Then, the subtractor 33a calculates a current deviation ΔIa by subtracting the motor current detected value Iadet from the a-phase current instruction value Iaref, the subtractor 33b calculates a current deviation ΔIb by subtracting the motor current detected value Ibdet from the b-phase current instruction value Ibref, and the subtractor 33c calculates a current deviation ΔIc by subtracting the motor current detected value Icdet from the c-phase current instruction value Icref.

Then, the calculated current deviations ΔIa, ΔIb, and ΔIc are supplied to a PI current controller 34, and this PI current controller 34 calculates voltage instruction values Varef, Vbref, and Vcref of the respective phases by performing PI control computing operation, and the calculated voltage instruction values Varef, Vbref, and Vcref are subjected to feed-forward compensation by a feed forward compensator 35.

The feed-forward compensator 35 includes disturbance compensation voltage computing sections 41a, 41b, and 41c which calculate feed-forward compensation values Vfa, Vfb, and Vfc based on the current instruction values Iref computed by the steering auxiliary current instruction value computing section 31 and the electric angle θ and the motor angular velocity ω calculated by the rotation information detector 22 inputted therein, and adders 42a, 42b, and 42c which perform feed-forward compensation by adding the feed-forward compensation values Vfa, Vfb, and Vfc calculated by the disturbance compensation voltage computing sections 41a, 41b, and 41c to the voltage instruction values Varef, Vbref, and Vcref outputted from the PI current controller 34.

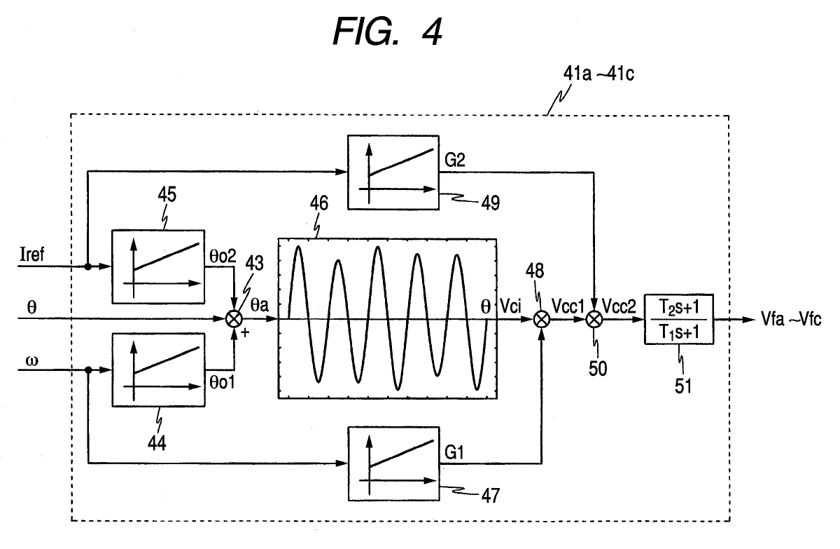

Herein, each of the disturbance compensation voltage computing sections 41a through 41c includes, as shown in FIG. 4, an adder 43 to be supplied with the inputted electric angle θ, a first offset value generator 44 which calculates an offset value θo1 based on the inputted motor angular velocity ω, to offset the electric angle θ and supplies it to the adder 43, a second offset value generator 45 which calculates an offset value θo2 based on the inputted current instruction value Iref, to offset the electric angle θ and supplies it to the adder 43, and a disturbance compensation voltage model 46 which calculates a disturbance compensation voltage Vc based on an electric angle corrected value θa inputted therein to which the offset values θo1 and θo2 are added by the adder 43.

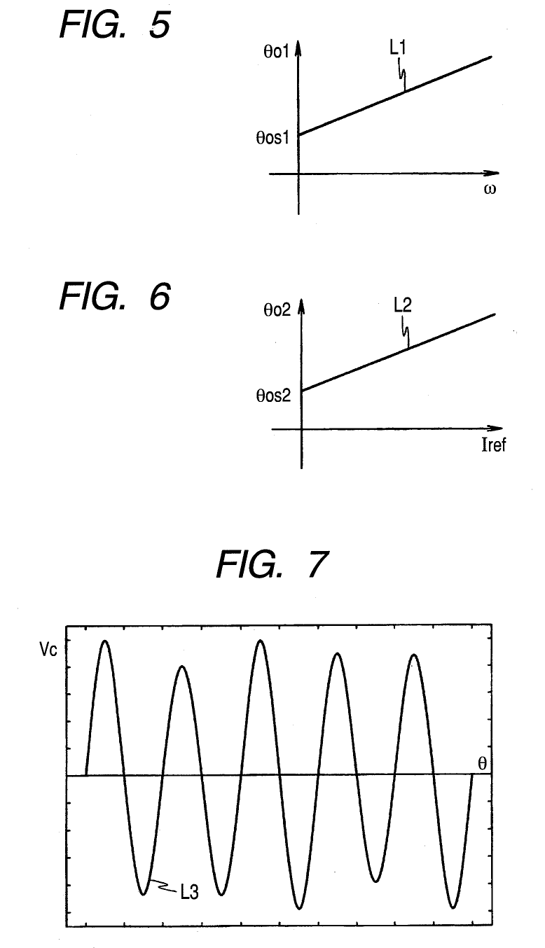

The first offset value generator 44 calculates a first offset value θo1 by referring to a first offset value calculation map shown in FIG. 5 based on the motor angular velocity ω. Herein, as shown in FIG. 5, the first offset value calculation map is a graph indicating the motor angular velocity ω on the horizontal axis and the first offset value θo1 on the vertical axis, and a characteristic line L1 is set therein so that the first offset value θo1 reaches a predetermined value θos1 when the motor angular velocity ω is “0,” and when the motor angular velocity ω increases from this state, according to the increase in motor angular velocity ω, the first offset value θo1 gradually increases or decreases from the predetermined value θos1.

Similarly, the second offset value generator 45 calculates a second offset value θo2 by referring to a second offset value calculation map shown in FIG. 6 based on the current instruction value Iref. Herein, the second offset value calculation map is a graph indicating the current instruction value Iref on the horizontal axis and the second offset value θo2 on the vertical axis as shown in FIG. 6, and a characteristic line L2 is set therein so that the second offset value θo2 reaches a predetermined value θos2 when the current instruction value Iref is “0,” and as the current instruction value Iref increases from this state, according to the increase in current instruction value Iref, the second offset value θo2 gradually increases or decreases from the predetermined value θo2.

Further, the disturbance compensation voltage model 46 calculates a disturbance compensation voltage Vc by referring to a disturbance compensation voltage calculation map shown in FIG. 7 based on the electric angle corrected value θa. Herein, in the disturbance compensation voltage calculation map, as shown in FIG. 7, a characteristic curve L3 is set by obtaining a disturbance compensation voltage Vc including nonlinear disturbance characteristics of the current control system (PI current controller 34, the motor driving circuits 36 and 37 described later, and the 3-phase brushless motor 12) corresponding to the electric angle θ through simulations and experiments.

The disturbance compensation voltage computing section 41 includes a first amplitude gain calculator 47 which calculates a first amplitude gain based on the inputted motor angular velocity ω, a first corrector 48 which multiplies the disturbance compensation voltage Vc outputted from the disturbance compensation voltage model 46 by the first amplitude gain calculated by the first amplitude gain calculator 47, a second amplitude gain calculator 49 which calculates a second amplitude gain based on the inputted current instruction value Iref, a second corrector 50 which multiplies the disturbance compensation voltage corrected value Vcc1 outputted from the first corrector 48 by the second amplitude gain calculated by the second amplitude gain calculator 49, and a phase lead/lag compensator 51 which applies phase lead/lag compensation to the disturbance compensation voltage corrected value Vcc2 outputted from the second corrector 50.

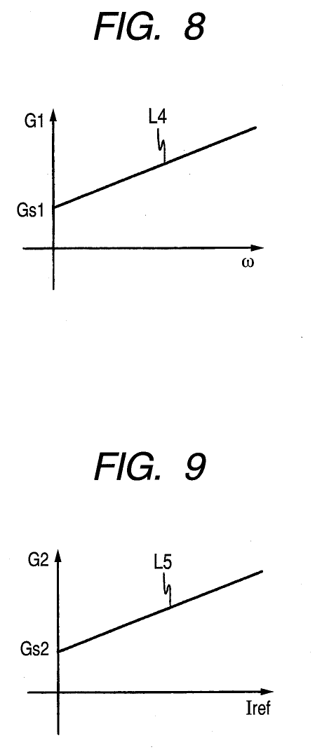

The first amplitude gain calculator 47 calculates a first amplitude gain G1 by referring to a first amplitude gain calculation map shown in FIG. 8 based on the motor angular velocity ω. Herein, as shown in FIG. 8, the first amplitude gain calculation map is a graph indicating the motor angular velocity ω on the horizontal axis and the first amplitude gain G1 on the vertical axis, and a characteristic line L4 is set therein so that the first amplitude gain G1 reaches a predetermined value Gs1 when the motor angular velocity ω is “0,” and when the motor angular velocity ω increases from this state, according to the increase in motor angular velocity ω, the first amplitude gain G1 gradually increases or decreases from the predetermined value Gs1.

The second amplitude gain calculator 49 calculates a second amplitude gain G2 by referring to a second amplitude gain calculation map shown in FIG. 9 based on the current instruction value Iref. Herein, the second amplitude gain calculation map is a graph indicating the current instruction value Iref on the horizontal axis and the second amplitude gain G2 on the vertical axis as shown in FIG. 9, and a characteristic line L5 is set therein so that the second amplitude gain G2 reaches a predetermined value Gs2 when the current instruction value Iref is “0,” and when the current instruction value Iref increases from this state, according to the increase in current instruction value Iref, the second amplitude gain G2 gradually increases or decreases from the predetermined value Gs2.

Further, in the phase lead/lag compensator 51, primary transmission characteristics expressed as (T₂s+1)/(T₁s+1) are set.

Then, compensation voltage instruction values Varef′, Vbref′ and Vcref′ feed-forward compensated by the feed-forward compensator 35 are supplied to a pulse width modulation (PWM) controller 36, and this pulse width modulation controller 36 forms gate pulse signals of the respective phases for an inverter circuit 37 and supplies the gate pulse signals to the inverter circuit 37, whereby 3-phase motor currents Ia, Ib, and Ic are formed, and these 3-phase motor currents Ia, Ib, and Ic are supplied to the 3-phase brushless motor 12.

Next, operations of the above-described embodiment will be described.

Now, when the steering wheel 1 is steered, a steering torque T of this steering is detected by the steering torque sensor 3, and a vehicle speed V is detected by the vehicle speed sensor 21. Then, the detected steering torque T and vehicle speed V are inputted into the steering auxiliary current instruction value computing section 31 of the steering auxiliary control device 20, and this steering auxiliary current instruction value computing section 31 calculates a steering auxiliary current instruction value Iref by referring to the steering auxiliary current instruction value calculation map of FIG. 3.

On the other hand, a motor angle detection signal θm detected by the motor rotation angle sensor 13 is supplied to the rotation information detector 22 and converted into an electric angle θ, and a motor angular velocity ω is calculated.

Then, the steering auxiliary current instruction value Iref calculated by the steering auxiliary current instruction value computing section 31 and the electric angle θ are supplied to the vector control current instruction value computing section 32, and this vector control current instruction value computing section 32 calculates a d-axis current instruction value Idref and a q-axis current instruction value Iqref by performing a d-q axis current instruction value computing operation based on the steering auxiliary current instruction value Iref and the electric angle θ, and by 2-phase/3-phase converting the calculated d-axis current instruction value Idref and q-axis current instruction value Iqref, calculates an a-phase current instruction vale Iaref, b-phase current instruction value Ibref, and a c-phase current instruction value Icref for the 3-phase brushless motor 12.

Then, the respective phase current instruction values Iaref, Ibref, and Icref calculated by the vector control current instruction value computing section 32 are supplied to the subtracters 33a, 33b, and 33c, and current deviations ΔIa, ΔIb, and ΔIc are calculated by subtracting the motor current detected values Iadet, Ibret, and Icret detected in the motor current detector 38 from the respective current instruction values Iaref, Ibref, and Icref, and these current deviations ΔIa, ΔIb, and ΔIc are supplied to the PI current controller 34, and voltage instruction values Varef, Vbref, and Vcref of the respective phases for the 3-phase brushless motor 12 are calculated.

Based on these voltage instruction values Varef, Vbref, and Vcref, the PWM controller 36 forms pulse width modulation signals, and these signals are supplied to the inverter circuit 37 and 3-phase currents are supplied to the 3-phase brushless motor 12, whereby the brushless motor 12 is driven and generates a steering auxiliary force corresponding to the steering auxiliary current instruction value Iref. Then, the steering auxiliary force generated in the brushless motor 12 is transmitted to the output shaft 2b of the steering shaft 2 via the reduction gear 11, and accordingly, the steering wheel 1 can be steered with a small steering force.

However, in this embodiment, the feed-forward compensator 35 is provided, and this feed-forward compensator 35 feed-forward compensates the voltage instruction values Varef, Vbref, and Vcref of the respective phases of the 3-phase brushless motor 12 outputted from the PI current controller 34.

In other words, the disturbance compensation voltage computing sections 41a, 41b, and 41c of the feed-forward compensator 35 calculates feed-forward compensation values Vfa, Vfb, and Vfc based on the electric angle θ and the motor angular velocity ω computed by the rotation information detector 22 and the steering auxiliary current instruction value Iref computed by the steering auxiliary current instruction value computing section 31.

At this time, the disturbance compensation voltage computing sections 41a, 41b, and 41c prepare a disturbance compensation voltage model 46 representing the relationship between the electric angle θ and the disturbance compensation voltage Vci (i=a, b, c) including nonlinear disturbance characteristics of the current control system including the current controller 34, the motor driving circuits 36 and 37, and the 3-phase brushless motor 12 through simulations and experiments as shown in FIG. 4, and on the input side of this disturbance compensation voltage model 46, an adder 43 which adds the first offset value θo1 calculated by the first offset value generator 44 based on the motor angular velocity ω and the second offset value θo2 calculated by the second offset value generator 45 based on the steering auxiliary current instruction value Iref to the electric angle θ is provided, and on the output side of the disturbance compensation voltage model 46, a multiplier 48 which multiplies the first amplitude gain G1 calculated by the first amplitude gain calculator 47 based on the motor angular velocity ω and a multiplier 50 which multiplies the second amplitude gain G2 calculated by the second amplitude gain calculator 49 based on the steering auxiliary current instruction value Iref are provided, and a disturbance compensation voltage corrected value Vcc2 corrected by multiplying by the first amplitude gain G1 and the second amplitude gain G2 by the multipliers 48 and 50 is subjected to the phase lead/lag compensation by the phase lead/lag compensator 51, whereby feed-forward compensation values Vfa, Vfb, and Vfc are calculated.

Then, the calculated feed-forward compensation values Vfa, Vfb, and Vfc are supplied to the adders 42a, 42b, and 42c and added to the voltage instruction values Varef, Vbref, and Vcref outputted from the PI current controller 34, whereby compensation voltage instruction values Varef′, Vbref′, and Vcref′ are supplied to the pulse width modulation controller 36.

Therefore, the pulse width modulation controller 36 forms gate pulse signals of the respective phases for the inverter circuit 37, and supplies these gate pulse signals to the inverter circuits 37, whereby 3-phase motor currents Ia, Ib, and Ic are formed, and these 3-phase motor currents Ia, Ib, and Ic are supplied to the 3-phase brushless motor 12.

Therefore, according to the disturbance compensation voltage model 46 in the disturbance compensation voltage computing section 41, the disturbance compensation voltages Vca, Vcb, and Vcc for compensating nonlinear disturbance characteristics of the current control system including the current controller 34, the motor driving circuits 36 and 37, and the 3-phase brushless motor 12 can be obtained based on the inputted electric angle correction value θa.

At this time, in the inputted electric angle correction value θa, the first offset value θo1 based on the motor angular velocity ω and the second offset value θo2 based on the steering auxiliary current instruction value Iref are added to the electric angle θ. Therefore, disturbance caused by current distortion according to the responsiveness of the current control system can be compensated by the first offset value θo1. In addition, disturbance of an error caused by distortion of the electromotive force EMF according to the armature reaction of the 3-phase brushless motor 12 can be compensated by the second offset value θo2.

Further, the two multipliers 48 and 50 provided on the output side of the disturbance compensation voltage model 46 multiplies the disturbance compensation voltages Vac, Vbc, and Vcc outputted from the disturbance compensation voltage model 46 by the first amplitude gain G1 calculated based on the motor angular velocity ω and the second amplitude gain G2 calculated based on the steering auxiliary current instruction value Iref. Therefore, the current distortion according to the responsiveness of the above-described current control system can be compensated by the first amplitude gain G1, and disturbance of an error caused by distortion of the electromotive force EMF due to the armature reaction of the 3-phase brushless motor 12 can be compensated by the second amplitude gain G2.

Then, by making the disturbance compensation voltage correction value Vcc2 outputted from the multiplier 50 pass through the phase lead/lag compensator 51, phase lead/lag compensation is performed and the feed-forward compensation values Vfa, Vfb, and Vfc are supplied to the adders 42a, 42b, and 42c and added to voltage instruction values Varef, Vbref, and Vcref outputted from the PI current controller 34 to calculate compensation voltage instruction values Varef′, Vbref′, and Vcref′.

Therefore, in the feed forward compensator 35, when a current is applied to the 3-phase brushless motor 12, two points of a point at which a torque ripple corresponding to distortion of the electromotive force due to the armature reaction occurs and a point at which the responsiveness of the current control system is lowered in a high-rotation state and a necessary correction current cannot be supplied (the responsiveness is especially lowered in a harmonic component) and a torque ripple occurs are regarded as disturbances, and to simultaneously compensate these, in the disturbance compensation voltage computing section 41, a disturbance compensation voltage for compensating nonlinear disturbance characteristics of the current control system is computed according to the electric angle θ and feed-forward compensation values Vfa, Vfb, and Vfc are calculated by using the current instruction value Iref to correct the influence of the armature reaction of the 3-phase brushless motor 12, and to correct the influence of the responsiveness of the current control system, by using the motor angular velocity ω, and based on these feed-forward compensation values Vfa, Vfb, and Vfc, voltage instruction values Varef, Vbref, and Vcref outputted from the PI current controller 34 are feed-forward compensated. Therefore, the disturbances can be directly compensated without any influence according to the responsiveness of the current control system, and the compensation system can be constructed by a simple structure, so that compensation can be performed with a small operation load.

In addition, by applying the motor control device having the above-described effect to an electric power steering device, an electric power steering device which offers superior silence and responsiveness that prevents being lowered in a high-rotation state can be provided.

In the above-described embodiment, a description is given about the case where in the disturbance compensation voltage computing section 41, on the input side of the disturbance compensation voltage model 46, the electric angle θ is corrected according to the first offset value θo1 based on the motor angular velocity ω and the second offset value θo2 based on the steering auxiliary current instruction value Iref, and on the output side of the disturbance compensation voltage model 46, disturbance compensation voltages Vac, Vbc, and Vcc are corrected according to the first amplitude gain G1 based on the motor angular velocity ω and the second amplitude gain G2 based on the steering auxiliary current instruction value Iref, however, the present invention is extended to the scope of the present invention can be applied, it is allowed that either or both of the offset value generators 44 and 45 is omitted and either or both of the amplitude gain calculators 47 and 49 is omitted.

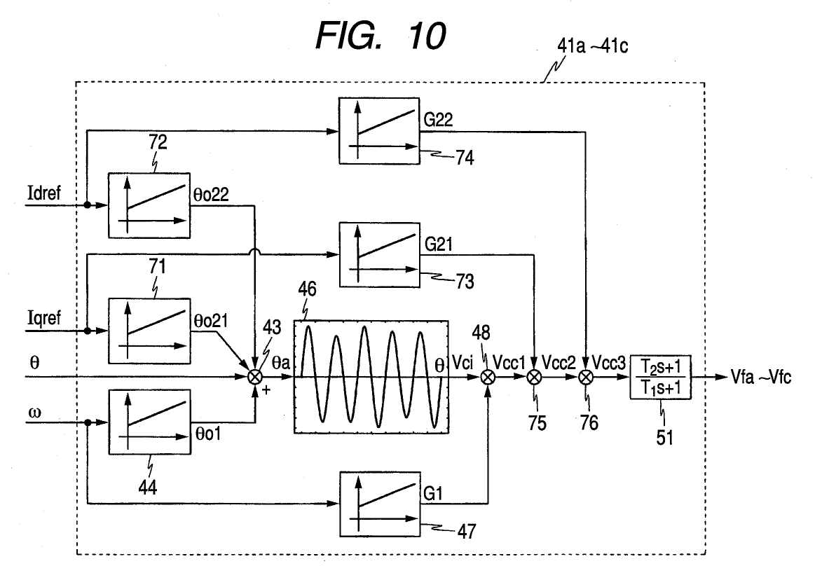

In the above-described embodiment, the current instruction value to be inputted for calculating the second offset value θo2 and the second amplitude gain G2 is the steering auxiliary current instruction value Iref, however, the present invention is extended to the scope of the present invention can be applied, and for example, the q-axis current instruction value Iqref and the d-axis current instruction value Idref may be used. In this case, as shown in FIG. 10, it is allowed that the second offset generator 71 calculates a second offset value θo21 based on the q-axis current instruction value Iqref, and the second offset generator 72 calculates a second offset value θo22 based on the d-axis current instruction value Idref, and these are supplied to the adder 43, and further, the second gain calculator 73 calculates a second amplitude gain G21 based on the q-axis current instruction value Iqref and the second gain calculator 74 calculates a second amplitude gain G22 based on the d-axis current instruction value Idref, a multiplier 75 multiplies a multiplication output Vcc1 of the multiplier 48 by the second amplitude gain G21, and a multiplier 76 multiplies a multiplication output Vcc2 of the multiplier 75 by the second amplitude gain G22, and a multiplication output Vcc3 of this multiplier 76 is supplied to the phase lead/lag compensator 51.

In the above-described embodiment, the case where the d-axis current instruction value Idref and the q-axis current instruction value Iqref are 2-phase/3-phase converted into 3-phase instruction current values Iaref, Ibref, and Icref and then supplied to the subtracters 33a, 33b, and 33c, is described, however, the present invention is extended to the scope of the present invention can be applied, it is also allowed that the 2-phase/3-phase conversion is omitted, and instead of this, motor current detected values Iadet and Ibdet detected by the motor current detector 38 and a current value Icdet estimated by this detector are supplied to a 3-phase/2-phase converter and converted into a d-axis detected current and q-axis detected current, and current deviations between the converted d-axis detected current and q-axis detected current and the d-axis current instruction value Idref and the q-axis current instruction value Iqref computed by the vector control current instruction value computing section 32 are calculated, and then the current deviations are 2-phase/3-phase converted and supplied to the PI current controller 34.

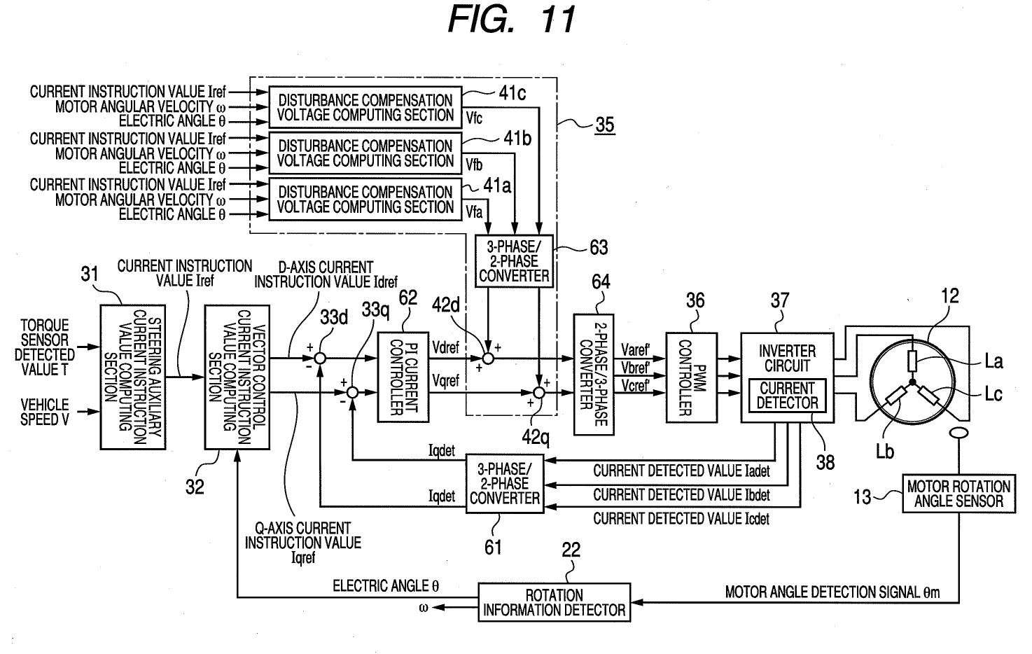

Further, in the above-described embodiment, the case where the voltage instruction values Varef, Vbref, ad Vcref of the respective phases of the 3-phase brushless motor 12 are outputted from the PI current controller 34 is described, however, the present invention is extended to the scope of the present invention can be applied, as shown in FIG. 11, it is allowed that the 2-phase/3-phase conversion of the vector control current instruction value computing section 32 is omitted, and the d-axis current instruction value Idref and the q-axis current instruction value Iqref are supplied to the subtracters 32d and 32q, and on the other hand, motor current detected values Iadet, Ibdet, and Icdet outputted from the motor current detector 38 are converted by the 3-phase/2-phase converter 61 into a d-axis current detected value Iddet and a q-axis current detected value Iqdet, and these d-axis current detected value Iddet and q-axis current detected value Iqdet are supplied to the subtracters 32d and 32q, and current deviations ΔId and ΔIq outputted from the subtracters 32d and 32q are supplied to the PI current controller 62 and PI current control operation is performed, whereby a d-axis voltage instruction value Vdref and a q-axis voltage instruction value Vqref are calculated.

Even in a case where the adders 42a through 42c of the feed-forward compensator 35 are omitted, and instead of these, a 3-phase/2-phase converter 63 is provided on the output side of the disturbance compensation voltage computing section 41, and the feed-forward compensation values Vfa through Vfc are converted by this 3-phase/2-phase converter 63 into a d-axis feed-forward compensation value Vfd and a q-axis feed-forward compensation value Vfq and then supplied to adders 42d and 42q, the d-axis voltage instruction value Vdref and the q-axis voltage instruction value Vqref outputted from the PI current controller 62 are supplied to these adders 42d and 42q, and compensation voltage instruction values Vdref′ and Vqref′ outputted from the adders 42d and 42q are supplied to a 2-phase/3-phase converter 64 and converted into 3-phase voltage instruction values Varef through Vcref and supplied to the pulse width modulation controller 36, the same working-effect as in the above-described embodiment can be obtained.

Further, in the above-described embodiment, the case where the present invention is applied to a 3-phase brushless motor is described, however, the present invention is extended to the scope of the present invention can be applied, the present invention can also be applied to n(4 or more)-phase brushless motors.

Further, in the above-described embodiment, the case are the present invention is applied to an electric power steering device is described, however, the present invention is extended to the scope of the present invention can be applied, the present invention can also be applied to equipment to which an n-phase brushless motor is applied, such as in-vehicle electrically-powered equipment including an electric braking device, etc., and other electrically-powered equipment.

What is claimed is:

1. A motor driving control device comprising:
a current instruction value computing section which computes a current instruction value for driving a brushless motor;
a motor current detector which detects a motor current of the brushless motor;
a current controller which computes a voltage instruction value based on the current instruction value and the motor current;
a rotation information detector which detects an electric angle and a rotation angular velocity of the brushless motor;
a disturbance compensation voltage computing section which computes a disturbance compensation voltage value based on the current instruction value, the electric angle of the brushless motor, and the rotation angular velocity of the brushless motor; and
a feed forward compensator which corrects the voltage instruction value outputted from the current controller based on the disturbance compensation voltage value computed in the disturbance compensation voltage computing section.

2. The motor driving control device according to claim 1, wherein
the disturbance compensation voltage computing section has a disturbance compensation voltage model for calculating a disturbance compensation voltage based on the electric angle.

3. The motor driving control device according to claim 2, wherein
the disturbance compensation voltage computing section includes: a first offset value generator which generates an offset value based on the rotation angular velocity of the brushless motor, to offset the rotation angle, which is inputted into the disturbance compensation voltage model.

4. The motor driving control device according to claim 2, wherein
the disturbance compensation voltage computing section includes: a second offset value generator which generates an offset value based on the current instruction value, to offset the rotation angle, which is inputted into the disturbance compensation voltage model.

5. The motor driving control device according to claim 2, wherein
the disturbance compensation voltage computing section includes: a first corrector which multiplies a disturbance compensation voltage outputted from the disturbance compensation voltage model by a first amplitude gain calculated based on the rotation angular velocity of the brushless motor.

6. The motor driving control device according to claim 2, wherein
the disturbance compensation voltage computing section includes: a second corrector which multiplies a disturbance compensation voltage outputted from the disturbance compensation voltage model by a second amplitude gain calculated based on the current instruction value.

7. The motor driving control device according to claim 2, wherein
the disturbance compensation voltage computing section includes: a phase lead/lag compensator which performs phase lead/lag compensation for the disturbance compensation voltage on an output side of the disturbance compensation voltage model.

8. An electric power steering device, wherein
a brushless motor which generates a steering auxiliary force for a steering system is driven and controlled by the motor driving control device according to claim 1.
